(19) United States
(12) Patent Application Publication
(10) Pub. No.: US 2025/0141508 A1
(43) Pub. Date: May 1, 2025

(54) ALTERNATIVE EFFICIENT LOWER-LAYER SPLIT OPTION ENABLING CENTRALIZED BEAMFORMING FOR CASCADED DISTRIBUTED-MULTIPLE INPUT MULTIPLE OUTPUT

(71) Applicant: Telefonaktiebolaget LM Ericsson (publ), Stockholm (SE)

(72) Inventors: Yezi HUANG, Täby (SE); Chenguang LU, Sollentuna (SE); Miguel BERG, Sollentuna (SE)

(21) Appl. No.: 18/691,314

(22) PCT Filed: Sep. 15, 2021
(86) PCT No.: PCT/SE2021/050883

§ 371 Date: Mar. 12, 2024

(51) Int. Cl. H04B 7/06; H04W 72/0453

(52) U.S. Cl. CPC H04B 7/0617; H04W 72/0453

(57) ABSTRACT

A network entity can be in a communications network that includes a plurality of network nodes communicatively coupled to the network entity via a cascaded topology. The network entity can transmit scheduling information to a first network node of the plurality of network nodes. The network entity can further receive an indication of an intermediate beamforming weight from the first network node. The network entity can further determine a part of a frequency-domain beamforming weight based on the indication of the intermediate beamforming weight. The network entity can further transmit an indication of the part of the frequency-domain beamforming weight to the first network node. The network entity can further communicate data with the communication device via the first network node.

### TECHNICAL FIELD

The present disclosure relates generally to communications, and more particularly to communication methods and related devices and nodes supporting wireless communications.

### BACKGROUND

FIG. 1 illustrates an example of a new radio (“NR”) network (e.g., a 5th Generation (“5G”) network) including a 5G core (“5GC”) network 130, network node 120 (e.g., 5G base station (“gNB”)), multiple communication devices 110 (also referred to as user equipment (“UE”)).

### SUMMARY

According to some embodiments, a method performed by a network entity in a communications network is provided. The communication network includes a plurality of network nodes communicatively coupled to the network entity via a cascaded topology. The method includes transmitting scheduling information to a first network node of the plurality of network nodes. The scheduling information includes at least an indication of user layers to be used for communication with a communication device during a next transmission time interval and an indication of which user layers will be served by the first network node. The method further includes receiving an indication of an intermediate beamforming weight from the first network node. The method further includes determining a part of a frequency-domain beamforming weight based on the indication of the intermediate beamforming weight. The method further includes transmitting an indication of the part of the frequency-domain beamforming weight to the first network node. The method further includes communicating with the communication device via the first network node.

According to other embodiments, a method performed by a first network node of a plurality of network nodes in a communications network is provided. The plurality of network nodes are communicatively coupled to a first network entity via a cascaded topology. The method includes receiving scheduling information from a second network entity in the communication network includes at least an indication of user layers to be used for communication with a communication device in a next transmission time interval and an indication of which user layers will be served by the first network node. The method further includes determining an intermediate beamforming weight based on a channel estimate associated with a channel between the first network node and the communication device. The method further includes transmitting an indication of the intermediate beamforming weight to the second network entity. The method further includes receiving an indication of a part of a frequency-domain beamforming weight from the second network entity. The method further includes determining a frequency-domain beamforming weight based on the channel estimate and the first part of the frequency-domain beamforming weight. The method further including communicating data between the second network entity and the communication device using the frequency-domain beamforming weight.

According to other embodiments, a network entity, a first network node, a computer program, computer program code, and non-transitory computer-readable medium is proved to perform the methods above.

Various embodiments herein, provide one or more of the following technical advantages. In some embodiments, superior performance of centralized beamforming is achieved in a massive D-MIMO system without suffering from an exploding fronthaul load associated with a large number of RUs connecting to the BBU in a cascaded topology. By making use of the cascaded topology, both the deployment costs (due to the reduced number or length of required fibers) and the system complexity (due to the reduced number of required BBU ports) can be significantly reduced compared with the star topology. In some embodiments, a BBU saves some complexity since modulation and beamforming are performed in respective RU. In additional or alternative embodiments, in the U-plane, only coded bits are sent from BBU to each RU, which can be more compressed.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a block diagram illustrating an example of multiple radio units (“RUs”) communicatively coupled to a baseband unit (“BBU”) via a star topology.

FIG. 3 is a block diagram illustrating an example of multiple RUs communicatively coupled to a BBU via a cascaded topology.

FIG. 4 is a block diagram illustrating an example of multiple RUs communicatively coupled to a BBU for downlink (“DL”) according to some embodiments of inventive concepts;

FIG. 5 is a block diagram illustrating an example of multiple RUs communicatively coupled to a BBU for uplink (“UL”) according to some embodiments of inventive concepts;

FIG. 6 is a block diagram illustrating a communication device according to some embodiments of inventive concepts;

FIG. 7 is a block diagram illustrating a radio access network RAN node (e.g., a base station eNB/gNB) according to some embodiments of inventive concepts;

FIG. 8 is a block diagram illustrating a core network CN node (e.g., an AMF node, an SMF node, etc.) according to some embodiments of inventive concepts;

FIG. 9 is a flow chart illustrating an example of operations of a network entity (e.g., a BBU) according to some embodiments of inventive concepts;

FIG. 10 is a flow chart illustrating an example of operations of a first network node (e.g., a RU) according to some embodiments of inventive concepts;

FIG. 11 is a block diagram of a communication system in accordance with some embodiments;

FIG. 12 is a block diagram of a user equipment in accordance with some embodiments

FIG. 13 is a block diagram of a network node in accordance with some embodiments;

FIG. 14 is a block diagram of a host computer communicating with a user equipment in accordance with some embodiments;

FIG. 15 is a block diagram of a virtualization environment in accordance with some embodiments; and

FIG. 16 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Massive multiple-input multiple-output (“MIMO”) techniques were first adopted to practice in long term evolution (“LTE”) networks. In 5th generation (“5G”) networks, it has become a key technology component, which will be deployed in a much larger scale than in LTE. It features with a large number of antennas used on the base-station side, where the number of antennas is typically much larger than the number of user-layers, for example, 64 antennas serving 8 or 16 user-layers in frequency range 1 (“FR1”) (which includes sub-6 GHz frequency bands) and 256/512 antennas serving 2 or 4 layers in frequency range 2 (“FR2”) (which comprises frequency bands from 24.25 GHz to 52.6 GHZ).

Herein the term user layer can refer to an independent downlink (“DL”) or uplink (“UL”) data stream intended for one user. One user or communication devices (also referred to herein as a user equipment (“UE”)) may have one or multiple user layers. Massive MIMO can also be referred to as massive beamforming, which is able to form narrow beams focusing on different directions to counteract against the increased path loss at higher frequency bands. It also benefits multi-user MIMO which allows for transmissions from/to multiple users simultaneously over separate spatial channels resolved by the massive MIMO technologies, while keeping high capacity for each user. Therefore, it can significantly increase the spectrum efficiency and cell capacity.

At the base-station side, the interface between the baseband unit (“BBU”) and the radio unit (“RU”) is the fronthaul interface, whereas the interface between the BBU and the core network (“CN”) is the backhaul interface. The great benefits of massive MIMO at the air-interface also introduce new challenges at the base-station side. The legacy common public radio interface (“CPRI”)-type fronthaul transports time-domain quadrature (“IQ”) samples per antenna branch. As the number of antennas scales up in massive MIMO systems, the required fronthaul capacity also increases proportionally, which significantly drives up the fronthaul costs. To address this challenge, the fronthaul interface evolves from CPRI to enhanced CPRI (“eCPRI”), a packet-based fronthaul interface. In eCPRI, other functional split options between a BBU and a RU are supported, referred to as different lower-layer split (“LLS”) options. The basic idea is to move the frequency-domain beamforming function from BBU to RU so that frequency samples or data of user-layers are transported over the fronthaul interface. Note that the frequency-domain beamforming is sometimes also referred to as precoding in the DL direction and equalizing or pre-equalizing in UL direction. By doing this, the required fronthaul capacity and thereby the fronthaul costs can be significantly reduced, as the number of user layers is typically much fewer than the number of antennas in massive MIMO.

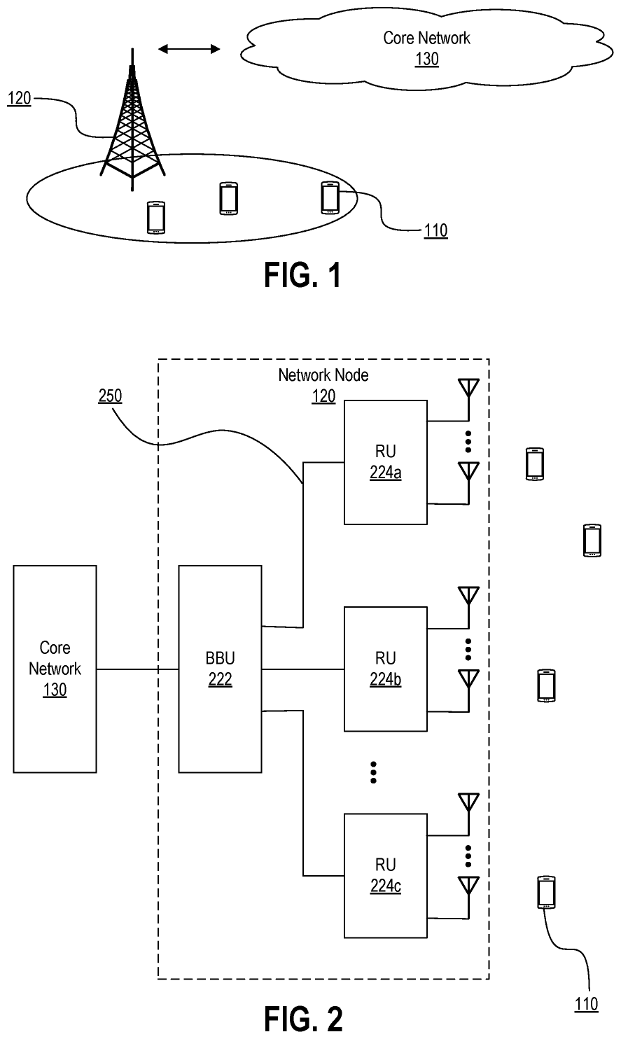

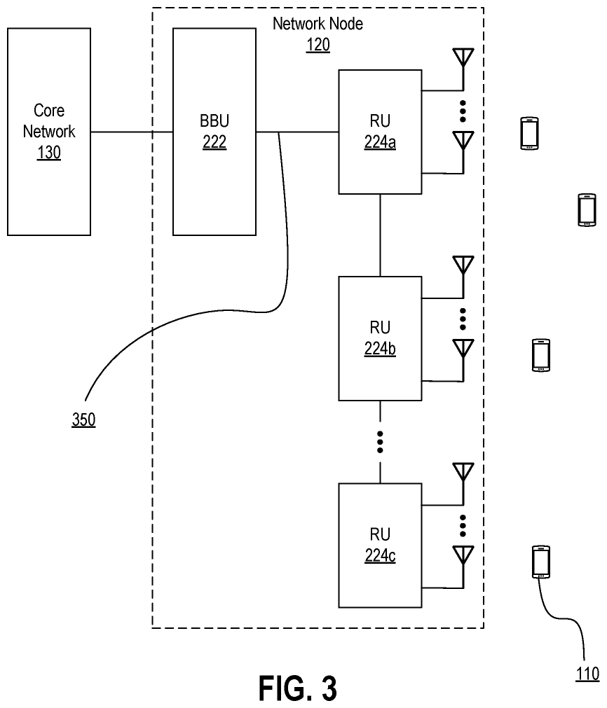

Massive distributed MIMO (“D-MIMO”) is likely to be important in the context of 5G evolution towards 6th generation (“6G”). Massive D-MIMO is also referred to as the cell free massive MIMO system. It is typically assumed to be based on time division duplexing (“TDD”), which considers reciprocity between UL and DL channels. FIGS. 2-3 illustrate an example of the core network 130, network node 120, and communication devices 110 of FIG. 1 implemented with D-MIMO.

In D-MIMO, a large number of distributed RUs 224a-c connect to a BBU 222 via fronthaul links 250, 350. The RUs 224a-c are deployed at distances. The inter-RU distance can be short or long. The connection between BBU 222 and distributed RUs 224a-c can be either in star topology where each RU 224a-c has a dedicated fronthaul link 250 to the BBU 222 and occupies a dedicate BBU port as shown in FIG. 2 or in cascaded topology where the RUs 224a-c share the same fiber connection 350 and the same BBU port as shown in FIG. 3 or a combination of the two topologies.

Compared to the star topology (FIG. 2), the cascaded topology (FIG. 3) may help reduce the deployment costs (e.g., fiber connections) and system complexity (e.g., BBU ports), especially considering the large number of RUs connected. In a massive D-MIMO system, multiple UEs can be served by more than one RU simultaneously using the same time-frequency resources, where the interferences between UEs can be mitigated. Theoretically, the best performance can be achieved if the interference mitigation is done centrally at the BBU, which uses all antennas available of all RUs for a joint processing of all UEs and enables coherent transmission or reception. Partial mitigation is achieved if the interference mitigation is done locally at each RU, which can only use the antennas at each RU, having much fewer degrees of freedom than that with central processing at BBU.

The following provide the definitions of the relevant terminologies used in this document.

The term radio unit (“RU”) can be used herein to refer to a network node (or a portion of a network node) that performs radio functions including a portion of physical layer (“PHY”) functions according to an LLS option. The RU can perform conversions between radio frequency (“RF”) signals and baseband signals. On the network side a RU can transmit and receive the frequency-domain IQ data (modulated user data) or unmodulated user data to and from BBU through a fronthaul interface (e.g. eCPRI). The RU can also transmit and receive the RF signals to and from UEs through its antennas.

The term baseband unit (“BBU”) can be used herein to refer to a network entity (e.g., a network node or a portion of a network node) that performs baseband processing. The BBU can communicatively couple to the CN via a backhaul interface or to a central unit (“CU”) via an F1 interface.

In an open radio access network (“O-RAN”) the BBU and RU can be referred to as O-DU and O-RU, respectively. In D-MIMO terminology, the RU can also be referred to as an access point (“AP”) and the BBU can be referred to as a central processing unit (“CPU”) or edge cloud processor. In some terminologies, the RU can also be referred to as remote radio unit (“RRU”) and the BBU can be referred to as a digital unit or distributed unit (“DU”). In eCPRI terminologies, the BBU and the RU are referred to as an eCPRI radio equipment control (“eREC”) and eCPRI radio equipment (“eRE”) respectively. In another terminology, a BBU and a RU may be referred to as a LLS-CU and a LLS-DU respectively. The BBU and its equivalence can also be softwarized or virtualized as Baseband Processing Function in a Cloud environment. Use of the terms BBU and RU herein are not intended to limit the application of the innovation, which can be used in any suitable wireless field.

The term beam can be used herein to refer to a directional beam formed by multiplying a signal with different weights, in frequency-domain, at multiple antennas such that the energy of the wanted signal is concentrated to a certain direction and/or the energy of the interference signal is nulled at a certain direction.

The term beamforming can be used herein to refer to a technique which multiplies a signal with different weights (in frequency-domain) at multiple antennas, which enables the signal energy to be sent in space with a desired beam pattern by forming a directional beam concentrating on certain direction or forming nulling in certain direction, or a combination of both.

The term beamforming weight (“BFW”) can be used herein to refer to a set of one or more complex weights, each set is multiplied with a signal of one user-layer at a subcarrier or a group of subcarriers. In downlink, the weighted signals of different user layers towards the same antenna or transmit beam are combined linearly. As a result, different user-layer signals are beamformed towards their corresponding UEs constructively, other UEs destructively, or a combination of both. In uplink, the weighted received signals from different antennas or receive beams are combined linearly. It results in that the received signals at different antennas are constructively combined for the wanted user signals, destructively combined for the interference signals, or a combination of both.

The term user-layer can be used herein to refer to an independent downlink or uplink data stream intended for one user (or user device). In some examples, one user or UE may have one or multiple user-layers. One UEs should have multiple antennas to support more than one user-layers.

The terms desired cell and desired channel can be used herein to refer to the cell/channel which connects to the UEs of the K user-layers.

The term user-plane data can be used herein to refer to the frequency-domain user-layer data or frequency-domain spatial data streams (e.g. received signals from different antennas, beamformed received signals from multiple antennas) sent over fronthaul.

The term beamforming performance can be used herein to refer to signal quality in DL at the UE side after the beamforming has been performed at the base-station side, measured by, for example, post-processing signal-to-interference-and-noise-power ratio (“SINR”) at a UE, resulted user throughput, bit rate, etc. For UL, it refers to signal quality at the base station side after the beamforming has been performed at the base-station side, measured by, for example, post-processing signal-to-interference-and-noise-power ratio (“SINR”) at the base station side, resulted user throughput, bit rate, etc.

The term channel information can be used herein to refer to information about channel properties carried by the channel values. Channel value (also referred to as channel data) can refer to one or a set of complex values representing the amplitude and phase of the channel coefficients in frequency domain. The channel values are related to the frequency response of the wireless channel.

There currently exist certain challenges. Although the centralized massive D-MIMO performs the best, the implementation is constrained by the fronthaul network since centralized signal processing requires a huge amount of fronthaul data (e.g., user-plane signals regarding user layer data and control-plane signals regarding channel information and beamforming weights) to be exchanged between BBU and RUs. With a star-topology deployment, it would require many high-speed RU-BBU fronthaul (“FH”) links, each of which connects one RU to one port of the BBU. It also means that the required number of ports in BBU is the same as the number of connected RUs. It can become infeasible for a BBU to have so many ports when the number of RUs connected becomes massive. To reduce the number of required ports, fronthaul traffic can be aggregated using an Ethernet switch or IP router. However, this can dramatically increase the traffic of the aggregated port/link and therefore increase the costs. The same problem can occur for cascaded-topology deployment. The fronthaul traffic can quickly build up and generate more and more traffic load on fronthaul links closer to the BBU in the cascade chain.

Furthermore, for the BBU to conduct centralized beamforming in DL, the associated BFWs need to be obtained at the BBU.

If the channel estimation is conducted at the respective RU, each RU will need to send its estimated channel data to the BBU via the fronthaul link such that the BBU can get the channel data from all RRUs and calculate the BFWs. Let Nₗ denote the number of antennas at RU l and Kₗ denote the number of user-layers served by RU l. The data amount for channel data sent from RU l will be Kₗ×Nₗ complex values per physical resource block (“PRB”) bundle if the channel estimation is performed on one subcarrier per PRB bundle. Aggregation of the channel data from so many RUs would dramatically increase the traffic load in both the aggregated star-topology (on the aggregated fronthaul links) and the cascaded topology (on the fronthaul links closer to the BBU).

If the channel estimation is conducted at the BBU, each RU will need to send the received reference signal (if the channel estimation in UL will be used in the DL based on reciprocity) to the BBU via the fronthaul link. The data amount sent from RU l will be Nₗ complex values per scheduled reference symbol. Similar to the previous case, aggregation of reference signals would dramatically increase the traffic load in both the aggregated star-topology (on the aggregated fronthaul links) and the cascaded topology (on the fronthaul links closer to the BBU).

Given the above reasons, a compromise solution includes partially centralized processing relying on large-scale channel statistics (slow channel information, not the instantaneous channel information) or fully distributed processing (i.e. interference mitigation locally done in each RU). By doing so, exchanging of instantaneous channel information between BBU and RUs can be reduced or avoided, but at the cost of reduced spectrum efficiency compared to the fully centralized processing.

Certain aspects of the disclosure and their embodiments may provide solutions to these or other challenges. Various embodiments herein provide an efficient LLS option to enable centralized processing of massive D-MIMO in a cascaded topology in both DL and UL considering minimum mean squared error (“MMSE”)-based beamforming algorithms. The new LLS option reduces the FH data regarding channel information, making it scale with the number of served user layers, instead of the total number of antennas of all RUs in the system.

In some embodiments, channel estimation is conducted locally at the respective RUs and stored in a channel state memory at the respective RUs. Each RU can calculate intermediate BFWs (e.g., a covariance matrix of the local channel estimate of each RU), the dimension of which scales only with the number of user layers served by that RU. Each intermediate RU in the chain combines its own intermediate BFWs with the (possibly combined) intermediate BFWs received from the previous RU in the chain, and forwards updated combined intermediate BFWs to the next RU. The BBU can send the scheduling information including user-layer identification to each RU to assist the proper combination of the intermediate BFWs at each intermediate RU. This process continues until the intermediate BFWs arrive at the BBU. The BBU calculates a first part of BFWs for centralized interference mitigation based on the received combined intermediate BFWs. In control-plane (C-plane), the BBU can send the first part BFWs to each RU and each RU can conduct beamforming based both on the received first part BFWs and on the local channel estimates saved in its channel state memory. Since the first part BFWs only scale with the number of layers and the same first part BFWs are used for each RU, therefore the same amount of BFW data are sent no matter how many RUs are connected. In user-plane (U-plane), the BBU can send coded bits of each layer. Consequently, each RU can perform the modulation, resource element (“RE”) mapping, and a complete beamforming.

Certain embodiments may provide one or more of the following technical advantages. Some embodiments herein achieve superior performance of centralized beamforming in a massive D-MIMO system without suffering from the exploding fronthaul load associated with the large number of RUs connecting to the BBU in a cascaded topology. The required fronthaul load in user-plane (“UP”) and control-plane (“CP”) relating to the proposed BFWs will only be scaled with the total number of served user-layers. For example, the FH load is independent of: 1) the number of cascaded RUs; 2) the number of scheduled user layers at each RU; and 3) the number of antennas equipped at each RU. Some embodiments not only reduce the required fronthaul capacity to support the centralized beamforming for a D-MIMO system, but also results in a more balanced traffic load on the links between different RUs as well as between RU and BBU. In some embodiments, by making use of the cascaded topology, both the deployment costs (due to the reduced number or length of required fibers) and the system complexity (due to the reduced number of required BBU ports) can be significantly reduced compared with the star topology.

In some embodiments, a BBU saves some complexity since modulation and beamforming are performed in respective RU, compared to other embodiments in which modulation and the first part of beamforming are performed at the BBU. In additional or alternative embodiments, in the U-plane, only coded bits are sent from BBU to each RU, which can be more compressed. Although the C-plane data over the fronthaul interface is increased by sending the first part BFWs, the overall bit rate (U-plane and C-plane) can still be acceptable.

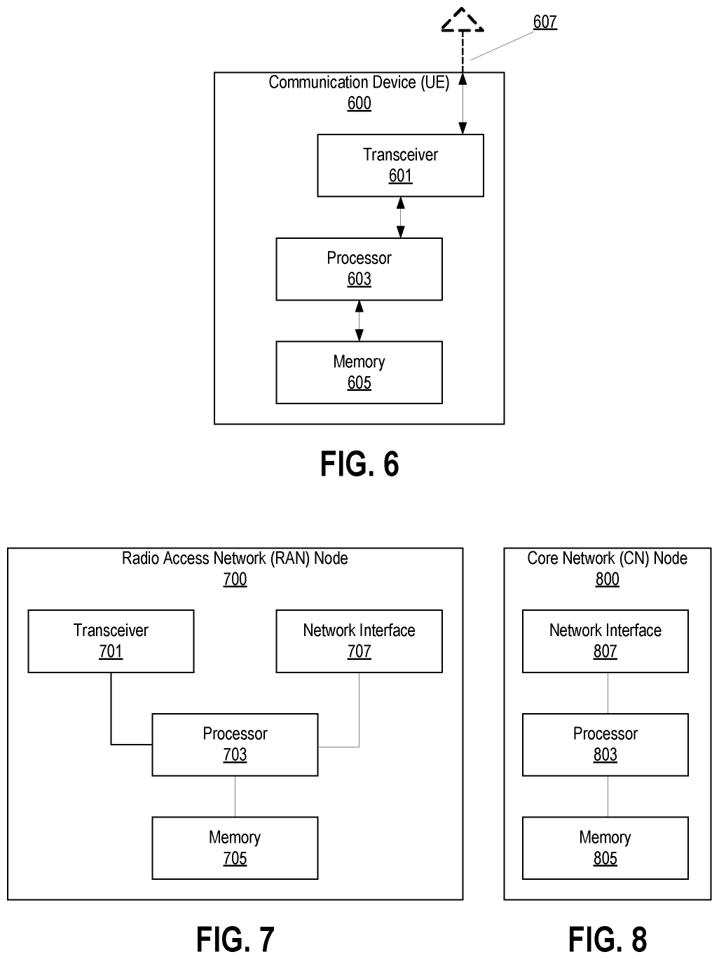

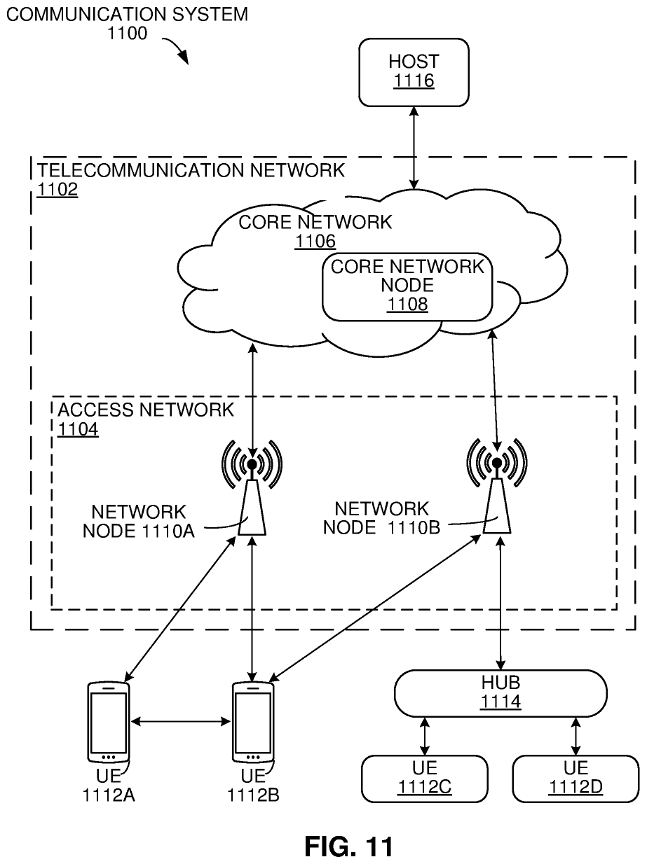

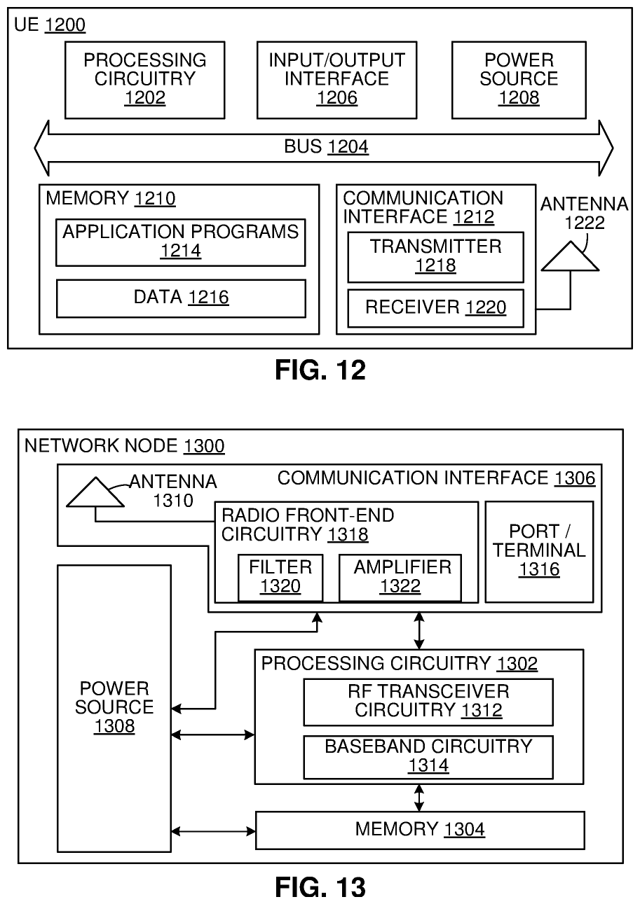

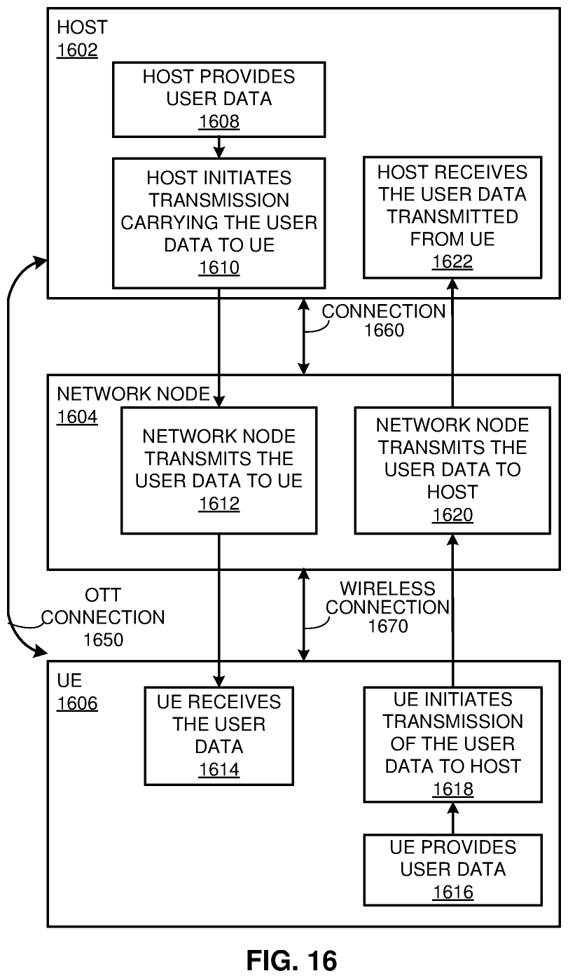

FIG. 6 is a block diagram illustrating elements of a communication device UE 600 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 600 may be provided, for example, as discussed below with respect to wireless devices UE 1112A, UE 1112B, and wired or wireless devices UE 1112C, UE 1112D of FIG. 11, UE 1200 of FIG. 12, virtualization hardware 1504 and virtual machines 1508A, 1508B of FIG. 15, and UE 1606 of FIG. 16, all of which should be considered interchangeable in the examples and embodiments described herein and be within the intended scope of this disclosure, unless otherwise noted.) As shown, communication device UE may include an antenna 307 (e.g., corresponding to antenna 1222 of FIG. 12), and transceiver circuitry 301 (also referred to as a transceiver, e.g., corresponding to interface 1212 of FIG. 12 having transmitter 1218 and receiver 1220) including a transmitter and a receiver configured to provide uplink and downlink radio communications with a base station(s) (e.g., corresponding to network node 1110A, 1110B of FIG. 11, network node 1300 of FIG. 13, and network node 1604 of FIG. 16 also referred to as a RAN node) of a radio access network. Communication device UE may also include processing circuitry 603 (also referred to as a processor, e.g., corresponding to processing circuitry 1202 of FIG. 12, and control system 1512 of FIG. 15) coupled to the transceiver circuitry, and memory circuitry 605 (also referred to as memory, e.g., corresponding to memory 1210 of FIG. 11) coupled to the processing circuitry. The memory circuitry 605 may include computer readable program code that when executed by the processing circuitry 603 causes the processing circuitry to perform operations according to embodiments disclosed herein. According to other embodiments, processing circuitry 603 may be defined to include memory so that separate memory circuitry is not required. Communication device UE may also include an interface (such as a user interface) coupled with processing circuitry 603, and/or communication device UE may be incorporated in a vehicle.

As discussed herein, operations of communication device UE may be performed by processing circuitry 603 and/or transceiver circuitry 601. For example, processing circuitry 603 may control transceiver circuitry 601 to transmit communications through transceiver circuitry 601 over a radio interface to a radio access network node (also referred to as a base station) and/or to receive communications through transceiver circuitry 601 from a RAN node over a radio interface. Moreover, modules may be stored in memory circuitry 605, and these modules may provide instructions so that when instructions of a module are executed by processing circuitry 603, processing circuitry 603 performs respective operations (e.g., operations discussed below with respect to Example Embodiments relating to wireless communication devices). According to some embodiments, a communication device UE 600 and/or an element(s)/function(s) thereof may be embodied as a virtual node/nodes and/or a virtual machine/machines.

FIG. 7 is a block diagram illustrating elements of a radio access network RAN node 700 (also referred to as a network node, base station, eNodeB/eNB, gNodeB/gNB, etc) of a Radio Access Network (RAN) configured to provide cellular communication according to embodiments of inventive concepts. (RAN node 700 may be provided, for example, as discussed below with respect to network node 1110A, 1110B of FIG. 11, network node 1300 of FIG. 13, hardware 1504 or virtual machine 1508A, 1508B of FIG. 15, and/or base station 1604 of FIG. 16, all of which should be considered interchangeable in the examples and embodiments described herein and be within the intended scope of this disclosure, unless otherwise noted.) As shown, the RAN node may include transceiver circuitry 701 (also referred to as a transceiver, e.g., corresponding to portions of RF transceiver circuitry 1312 and radio front end circuitry 1318 of FIG. 13) including a transmitter and a receiver configured to provide uplink and downlink radio communications with mobile terminals. The RAN node may include network interface circuitry 707 (also referred to as a network interface, e.g., corresponding to portions of communication interface 1306 of FIG. 13) configured to provide communications with other nodes (e.g., with other base stations) of the RAN and/or core network CN. The network node may also include processing circuitry 703 (also referred to as a processor, e.g., corresponding to processing circuitry 1302 of FIG. 13) coupled to the transceiver circuitry, and memory circuitry 705 (also referred to as memory, e.g., corresponding to memory 1304 of FIG. 13) coupled to the processing circuitry. The memory circuitry 705 may include computer readable program code that when executed by the processing circuitry 703 causes the processing circuitry to perform operations according to embodiments disclosed herein. According to other embodiments, processing circuitry 703 may be defined to include memory so that a separate memory circuitry is not required.

As discussed herein, operations of the RAN node may be performed by processing circuitry 703, network interface 707, and/or transceiver 701. For example, processing circuitry 703 may control transceiver 701 to transmit downlink communications through transceiver 401 over a radio interface to one or more mobile terminals UEs and/or to receive uplink communications through transceiver 701 from one or more mobile terminals UEs over a radio interface. Similarly, processing circuitry 703 may control network interface 407 to transmit communications through network interface 707 to one or more other network nodes and/or to receive communications through network interface from one or more other network nodes. Moreover, modules may be stored in memory 705, and these modules may provide instructions so that when instructions of a module are executed by processing circuitry 703, processing circuitry 703 performs respective operations (e.g., operations discussed below with respect to Example Embodiments relating to RAN nodes). According to some embodiments, RAN node 700 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

FIG. 8 is a block diagram illustrating elements of a core network (CN) node (e.g., an SMF (session management function) node, an AMF (access and mobility management function) node, etc.) of a communication network configured to provide cellular communication according to embodiments of inventive concepts. (CN node 800 may be provided, for example, as discussed below with respect to core network node 1108 of FIG. 11, hardware 1504 or virtual machine 1508A, 1508B of FIG. 15, all of which should be considered interchangeable in the examples and embodiments described herein and be within the intended scope of this disclosure, unless otherwise noted) As shown, the CN node may include network interface circuitry 807 configured to provide communications with other nodes of the core network and/or the radio access network RAN. The CN node may also include a processing circuitry 803 (also referred to as a processor) coupled to the network interface circuitry, and memory circuitry 805 (also referred to as memory) coupled to the processing circuitry. The memory circuitry 805 may include computer readable program code that when executed by the processing circuitry 803 causes the processing circuitry to perform operations according to embodiments disclosed herein. According to other embodiments, processing circuitry 803 may be defined to include memory so that a separate memory circuitry is not required.

As discussed herein, operations of the CN node may be performed by processing circuitry 803 and/or network interface circuitry 807. For example, processing circuitry 803 may control network interface circuitry 807 to transmit communications through network interface circuitry 807 to one or more other network nodes and/or to receive communications through network interface circuitry from one or more other network nodes. Moreover, modules may be stored in memory 505, and these modules may provide instructions so that when instructions of a module are executed by processing circuitry 503, processing circuitry 503 performs respective operations (e.g., operations discussed below with respect to Example Embodiments relating to core network nodes). According to some embodiments, CN node 500 and/or an element(s)/function(s) thereof may be embodied as a virtual node/nodes and/or a virtual machine/machines.

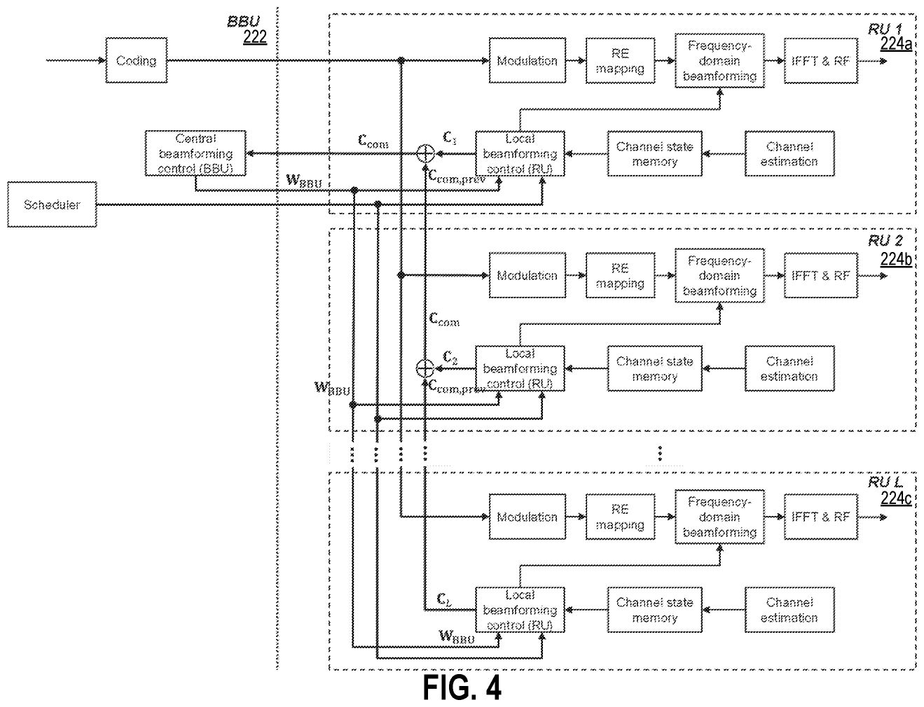

FIG. 4 is a block diagram illustrating an example of handling a DL signal according to some embodiments. In some examples, a total number of K user layers are served by a BBU 222, which is connected to L RUs 224a-c cascaded in a daisy chain, as shown in FIG. 3. RU 224a is the RU with fronthaul interface connecting to the BBU 222. Each RU l is equipped with Nₗ antennas and serves Kₗ (Kₗ≤K) user layers, the indices of which are in set [symbol] ₗ for l=1, . . . , L. Note that in this context, RU l serving a certain user-layer k means that the channel between RU l and user-layer k is configured (e.g., by the BBU 222) to be measured and this channel information is used to serve the wireless communication to user-layer k. The desired DL channel between RU l and the K user layers is denoted as Hₗ∈ [symbol] ^{K}^{ₗ}^{×N}^{ₗ} for l=1, . . . , L. To be simplified and without losing generality, the denotation of channel Hₗ and channel estimate Ĥₗ will not be differentiated in the following derivation. Only Hₗ will be used in mathematical explanation for convenience. Regarding the K user layers in the network, if a certain user layer k is not measured by RU l (the channel info will be not used by RU l), the channel between RU l and the user layer k can be denoted as 0^{T}, which is an 1×Nₗ zero vector. Define an extended channel matrix H̅ₗ∈ [symbol] ^{K×N}^{ₗ} that the k-th row of H̅ₗ is

$${\overline{H}}_{l} ( k , : ) = \{ \begin{matrix}{H}_{l} ( i , : ) & if k ∈ {l}_{} , and k = {l}_{} \{ i \} \\ {0}^{T} & if k ∉ {l}_{}\end{matrix} \qquad ( 1 )$$

For the BBU 222 to conduct centralized beamforming, it equivalently considers that the L RUs form a large antenna array. Without loss of generality, the effective channel of the large antenna array composed by all RUs 224a-c can be expressed as

$$H = [ \begin{matrix}{\overline{H}}_{1} & … & {\overline{H}}_{L}\end{matrix} ] ∈ {ℂ}^{K \times ( {\sum }_{l = 1}^{L} {N}_{l} )}$$

To conduct centralized reciprocity-assisted transmission (“RAT”) in DL, the beamforming weights can be calculated as

$$W = {H}^{H} {\underbrace{{( {HH}^{H} + {δ}^{2} I )}^{- 1}}}_{{W}_{BBU}} = [ \begin{matrix}{\overline{H}}_{1}^{H} \\ ⋮ \\ {\overline{H}}_{L}^{H}\end{matrix} ] {W}_{BBU} \qquad ( 2 )$$

Where H^{H} is the Hermitian transpose of H, I is a K×K identity matrix, and δ² is a regularization factor that can be calculated, for example, based on the trace of HH^{H} as well as interference and noise power. When δ²=0, it is equivalent to a zero-forcing (“ZF”)-based beamforming.

Note that

$${HH}^{H} = [ \begin{matrix}{\overline{H}}_{1} & … & {\overline{H}}_{L}\end{matrix} ] [ \begin{matrix}{\overline{H}}_{1}^{H} \\ ⋮ \\ {\overline{H}}_{L}^{H}\end{matrix} ] = {\sum }_{l = 1}^{L} {\overline{H}}_{l} {\overline{H}}_{l}^{H}$$

and the element at row k and column k′ of matrix H̅ₗH̅ₗ^{H} is expressed as

$$[ {\overline{H}}_{l} {\overline{H}}_{l}^{H} ] ( k , {k}^{′} ) = \{ \begin{matrix}{H}_{l} ( i , : ) {H}_{l}^{H} ( : , j ) & if k = {l}_{} \{ i \} and {k}^{′} = {l}_{} \{ j \} \\ 0 & if k ∉ {l}_{} or {k}^{′} ∉ {l}_{}\end{matrix}$$

So essentially, H̅ₗH̅ₗ^{H} can be obtained by HₗHₗ^{H} the elements of which are placed in a K×K matrix indexed by [symbol] ₗ.

Thus, after obtaining channel estimation of Hₗ, the l-th part of intermediate BFWs Cₗ=HₗHₗ^{H} can be calculated at each RU l. According to this invention, each RU 224a-c calculates the combined intermediate BFWs and forward it to the next RU 224a-c in the cascade chain. So, RU l also receives the combined intermediate BFWs C_{com} from the previous RU. To differentiate between the received combined intermediate BFWs and the updated combined intermediate BFWs at RU l, the received combined intermediate BFWs from the previous RU is also denoted as C_{com,prev} where C_{com,prev}=Σₘ₌ₗ₋₁^{L}H̅ₘH̅ₘ^{H} for RU l. When updating the combined intermediate BFWs C_{com} at RU l, it conducts

$${C}_{com} ( k , {k}^{′} ) = {\sum }_{m = l}^{L} {\overline{H}}_{m} {\overline{H}}_{m}^{H} = \{ \begin{matrix}{H}_{l} ( i , : ) {H}_{l}^{H} ( : , j ) + {C}_{com , prev} ( k , {k}^{′} ) & if k = {l}_{} \{ i \} and {k}^{′} = {l}_{} \{ j \} \\ {C}_{com , prev} ( k , {k}^{′} ) & if k ∉ {l}_{} or {k}^{′} ∉ {l}_{}\end{matrix}$$

Note that in this process, the dimension of C_{com} is always K×K, i.e., it does not increase with respect to the number L of RUs.

Further note that C_{com} is always a Hermitian matrix which means C_{com}^{H}=C_{com}. Only transporting the upper triangular or lower triangular components of C_{com} between RUs is enough to convey the information carried by C_{com}. The upper triangular components of C_{com} are composed by all the entries above and including the main diagonal entries. The lower triangular components of C_{com} are composed by all the entries below and including the main diagonal entries. In this case, the number of intermediate BFWs that need to be transported between the cascaded RUs 224a-c as well as between RU 224a and BBU 222 is reduced from K² to (K²+K)/2. If RU l receives the upper or lower triangular components of C_{com} from the previous RU, it only needs to update C_{com} using the upper or lower triangular components of CZ.

Then, BBU 222 will receive from RU 1 the total combined intermediate BFWs of all RUs C_{com}=Σₗ₌₁^{L}H̅ₗH̅ₗ^{H}=HH^{H}. If only the upper triangular components of C_{com}, denoted by C_{com,u} is received, the BBU recovers C_{com} as

$${C}_{com} ( k , {k}^{′} ) = \{ \begin{matrix}{C}_{com , u} ( k , {k}^{′} ) & if k \leq {k}^{′} \\ {[ {C}_{com , u} ( {k}^{′} , k ) ]}^{*} & if k > {k}^{′}\end{matrix}$$

where [C_{com,u}(k′, k)]* denotes the complex conjugate of C_{com,u}(k′, k). If only the lower triangular components of C_{com}, denoted by C_{com,l} is received, the BBU 222 recovers C_{com} as

$${C}_{com} ( k , {k}^{′} ) = \{ \begin{matrix}{[ {C}_{com , l} ( {k}^{′} , k ) ]}^{*} & if k < {k}^{′} \\ {C}_{com , l} ( k , {k}^{′} ) & if k \geq {k}^{′}\end{matrix}$$

Using the received or recovered C_{com}=HH^{H}, the BBU 222 can also calculate the regularization factor δ² and thereby the first part BFWs

$${W}_{BBU} = {( {HH}^{H} + {δ}^{2} I )}^{- 1} = {( {C}_{com} + {δ}^{2} I )}^{- 1}$$

As illustrated in FIG. 4, the BBU 222 sends the first part BFWs W_{BBU} to the respective RU via RU 224a. Since W_{BBU} is also a Hermitian matrix, the fronthaul load of transporting W_{BBU} can also be saved by only transporting the upper or lower triangular components of W_{BBU}. In this case, the number of first part BFWs that need to be transported from BBU 222 to RU 224a as well as between the cascaded RUs 224a-c is also reduced from K² to (K²+K)/2. If only the upper or lower triangular components are received, each RU 224a-c needs to recover the original W_{BBU} before using it to calculate the BFWs. In the U-plane, coded bits or modulated symbols are sent in the DL from BBU 222 to the respective RU 224a-c, and the number of DL U-plane data stream is equal to K.

As shown in Eq. (2), the effective BFWs applied on the user layer signals at RU l is H̅ₗ^{H}W_{BBU}, where H̅ₗ^{H} can be obtained based on the local channel estimation at RU l. Since H̅ₗ^{H} has some zero-vector columns according to Eq. (1), it is equivalent to apply Hₗ^{H}\tilde{W}_{BBU,l}, where at RU l \tilde{W}_{BBU,l} is composed by Kₗ selected rows from W_{BBU} where the row indices are indicated by set [symbol] ₗ. This can also reduce the complexity of calculating BFWs at RU l by avoiding multiplication with zero-valued coefficients.

By doing so, some embodiments provide operations to conduct centralized beamforming which applies Eq. (2) without requiring transporting all instantaneous channel estimate of Hₗ for l=1, . . . , L obtained by the respective RU to the BBU 222 which imposes much higher requirement on the fronthaul capacity comparing to that of the invention.

The operations relative to FIG. 4 from the perspective of the RUs 224a-c are described below. The operations can be performed by a first Radio Unit, RU, 224a of a distributed base station system, the first RU 224a including N₁ antennas, the distributed base station system further including a Baseband Unit, BBU, 222 connected to the first RU 224a over a fronthaul link and a second RU 224b connected to the first RU 224a over an RU link, the second RU 224b including N₂ antennas, and a third RU 224c connected to the second RU 224b over an RU link, the third RU 224c including N₃ antennas,

In some embodiments, the operations include obtaining a first downlink, DL, channel estimate of the first RU 224a, denoted as Ĥ₁. In some examples, the channel estimate is between the first RU and a number of user layers, the size of which is denoted K₁. In additional or alternative examples, the channel estimate is based on reference signals (for example, sounding reference signal (“SRS”)) transmitted by the served UEs. The operations can further include storing the channel estimate in a channel state memory. Basically, the channel state memory stores the latest channel estimates of all served UEs.

The operations can further include receiving the scheduling information from BBU 222 (e.g., from the scheduler) indicating user layers to be transmitted in the next transmission time interval (“TTI”) and which user layers will be served by each RU 224a-c, and forwarding the scheduling information to the second RU 224b, which will also forward it to the following RU 224c (as well as any other RUs connected in the cascaded chain). In some examples, the RU 224a extracts the channel estimate Ĥ₁ regarding the scheduled user layers of the first RU 224a from the channel state memory.

The operations can further include determining a first part of intermediate BFWs C₁ to be used for centralized interference mitigation at the BBU 222 based on the first channel estimate Ĥ₁. In some examples, the first part of intermediate BFWs can be determined by C₁=Ĥ₁Ĥ₁^{H}.

The operations can further include receiving, from the second RU 224b, a combined intermediate BFWs based on C₂ and C₃ to be used for centralized interference cancellation at the BBU 222, C₂ being determined by the second RU 224b based on the second channel estimate Ĥ₂ and C₃ being determined by the third RU 224c based on the third channel estimate Ĥ₃. In some examples, the received combined intermediate BFWs are composed by the upper triangular components or lower triangular components.

The operations can further include combining the first intermediate BFWs C₁ and the received combined intermediate BFWs based on C₂ and C₃. If the row dimension of Ĥ₁, i.e., K₁, is equal to the total number of user layers K served by the BBU, the matrix dimension of C₁ will be the same as the received combined intermediate BFWs. Then the combining is done by directly adding C₁ and the received combined intermediate BFW matrix. If the row dimension of Ĥ₁, i.e., K₁, is smaller than the total number of user layers served by the BBU, the combining is done by adding the elements of C₁ to some elements of the received combined intermediate BFW matrix. The corresponding index information of where the addition is performed is indicated by the received scheduling information. If the received combined intermediate BFWs only contain the upper triangular components or lower triangular components, the combining is done based on the upper triangular components or lower triangular components of C₁.

The operations can further include sending, to the next unit in the uplink direction of the distributed base station system, the combined intermediate BFWs based on C₁, C₂ and C₃. In an example, in which the operations are being performed by the first RU 224a, the next unit is the BBU 222. In other examples, in which the operations are being performed by another RU 224b-c in the chain, the next unit is another RU (e.g., 224a-b), a radio gateway (“RGW”), or a function block in a RU. In additional or alternative examples, the sent combined intermediate BFWs only contain the upper triangular components or lower triangular components.

The operations can further include receiving, from a previous unit in the downlink direction of the distributed base station system a first part BFWs W_{BBU}. In some examples (such as for the RU 224a), the previous unit is the BBU 222. In other examples (such as for other RUs 224b-c), the previous unit is another RU (224a-b). In some embodiments, the received first part BFWs are composed by the upper triangular components or lower triangular components of W_{BBU}. In this case, the operations can further include recovering an original first part BFWs W_{BBU}. The recovering can be based on the Hermitian symmetric property of W_{BBU}.

The operations can further include forwarding the first part BFWs W_{BBU} to the second RU. In some embodiments, the forwarded BFWs only contain the upper triangular components or lower triangular components of W_{BBU}.

The operations can further include determining frequency-domain BFWs based on the first channel estimate Ĥ₁ stored in the channel state memory and the first part BFWs W_{BBU} received from the BBU 222. In some embodiments, the BFWs is A Ĥ₁^{H}\tilde{W}_{BBU,1}, where \tilde{W}_{BBU,1} is composed by K₁ selected rows from W_{BBU} where index information of which rows are selected is indicated by the received scheduling information from the BBU 222.

The operations can further include receiving, from the previous unit in the downlink direction of the distributed base station system, K user-layer downlink data streams to be sent to a number of UEs, where K is the total number of user layers served by the BBU 222. In some examples (such as for the RU 224a), the previous unit is the BBU 222. In other examples (such as for other RUs 224b-c), the previous unit is another RU (224a-b).

In some embodiments, the K data streams include coded bits. Each of the K data streams can include the coded bits of each user layer data. The original bits of the user layer data of each data stream can be encoded using a channel code (e.g., a low-density parity-check code, a Polar code, or a Turbo code) to generate the coded bits. In these embodiments, the first RU can further conduct modulation and RE mapping. Transporting coded bits can save FH bandwidth since it can consume less FH link capacity than if modulation is done at a BBU and if the modulated symbols are transported over a FH link. The modulation symbols can require more bits to achieve the required precision. For example, the coded bits before a 256-QAM modulation have only 8 bits. After modulation of 256-QAM, it may require 16 bits.

In additional or alternative embodiments, the K data streams include modulated symbols. The modulation can be done in a BBU. The original bits of each user layer data can be encoded using certain channel codes (e.g., a low-density parity-check code, a Polar code, or a Turbo code) to generate the coded bits. Then the coded bits are modulated (e.g., by a QAM modulator) to generate modulated symbols which are mapped from the coded bits to the constellation points in in-phase and quadrature, IQ, values, on the IQ plane (e.g., according to modulation orders). The IQ values of the constellation points of the modulated symbols are transported over the FH link. Here, modulated symbols can include the IQ values of the constellation points.

The operations can further include forwarding the K user-layer downlink data streams to the second RU. In some examples, frequency-domain beamforming is performed based on the determined BFWs and the K user-layer IQ data on respective subcarrier by multiplying the IQ data with the BFWs on the respective subcarriers.

The operations can further include sending the beamformed signals to the next step of the transmitter.

The operations relative to FIG. 4 from the perspective of the BBU 222 are described below. The operations can be performed by a Baseband Unit, BBU, 222 system of a wireless communication network. The wireless communication network can include a distributed base station system having a BBU, 222 a first RU 224a connected to the BBU 222 over a fronthaul link, the first RU 2224 can include N₁ antennas, and a second RU 224b connected to the first RU 224a over an RU link, the second RU 224b comprising N₂ antennas, and a third RU 224c connected to the second RU 224b over an RU link, the third RU 224c including N₃ antennas.

The operations can include sending the scheduling information from BBU 222 (scheduler) to the first RU 224a, indicating user layers to be transmitted in the next TTI and which user layers will be served by each RU 224a-c. The first RU 224a will forward the scheduling information to the second RU 224b, which will also forward it to the following RUs connected in the cascaded chain.

The operations can further include receiving, from the first RU 224a via the fronthaul link, combined intermediate BFWs based on a first part of intermediate BFWs C₁, a second part of intermediate BFWs C₂ and a third part of intermediate BFWs C₃, the first part of intermediate BFWs C₁ being determined by the first RU 224a based on a first channel estimate Ĥ₁ of wireless communication channels H₁ in the frequency domain between the N₁ antennas and a number of UEs, the second part of intermediate BFWs C₂ being determined by the second RU 224b based on a second channel estimate Ĥ₂ of wireless communication channels H₂ in the frequency domain between the N₂ antennas and a number of UEs, the third part of intermediate BFWs C₃ being determined by the third RU 224c based on a third channel estimate Ĥ₃ of wireless communication channels H₃ in the frequency domain between the N₃ antennas and a number of UEs. In some examples, the UEs served by different RUs can be either the same or different UEs. If the received combined intermediate BFWs only contain the upper triangular components or lower triangular components, the operations can further include recovering an original combined intermediate BFWs C_{com}. The recovering can be based on the Hermitian symmetric property of C_{com}.

If the BBU 222 receives combined intermediate BFWs, the operations can further include determining a first part BFWs W_{BBU} based on the received or recovered combined intermediate BFWs C_{com}. In some embodiments, the first part of BFWs can be obtained by W_{BBU}=(C_{com}+δ²I)⁻¹, where δ² is a regularization factor determined based on C_{com} and I is a K×K identity matrix. δ² can be equal to 0.

If the BBU 222 receives combined intermediate BFWs, the operations can further include sending, to the RU 224a via the fronthaul link, the first part BFWs W_{BBU}. In some embodiments, the sent first part BFWs are composed by the upper triangular components or lower triangular components of W_{BBU}.

The operations can further include sending, to the RU 224a via the fronthaul link, K user-layer downlink data streams to be sent to a number of UEs, where K is the total number of user layers served by the BBU 222. In some embodiments, the K data streams include coded bits. In additional or alternative embodiments, the K data streams include modulated symbols.

If the combined intermediate BFWs are received by an intermediate node (associating to one embodiment of the RU 224a which sends the combined intermediate BFWs to the intermediate node), the above operations of: receiving the combined intermediate BFWs (and the associated embodiments); determining the first part BFWs W_{BBU} (and the associated embodiments); and sending the first part BFWs to the RU 224a (and the associated embodiments) are performed by the intermediate node.

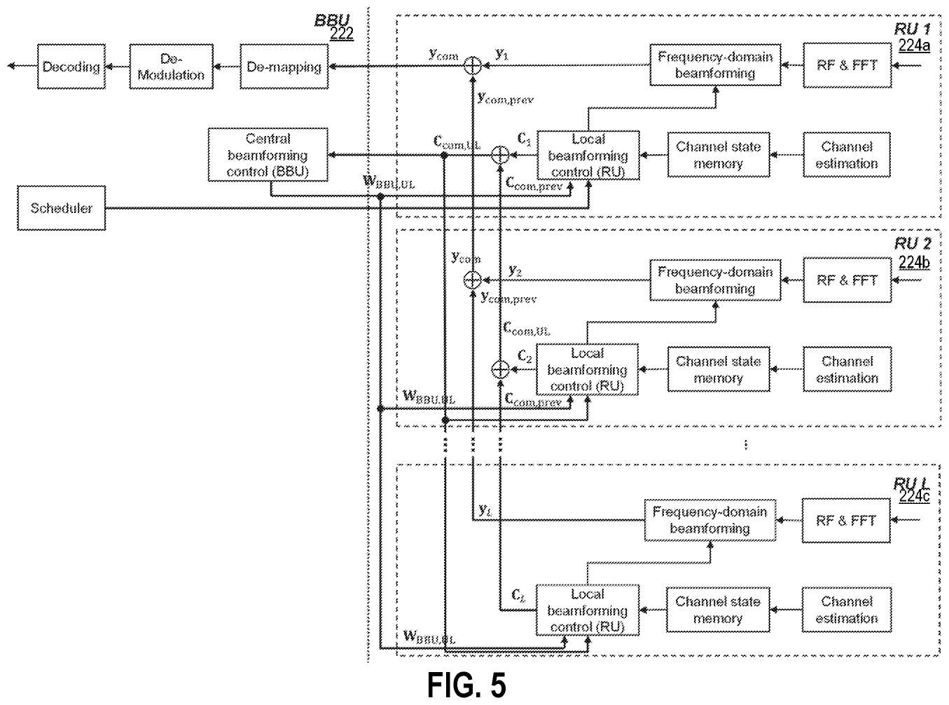

The same operations can also be implemented in the UL direction if MMSE-based beamforming algorithm will be used, as shown in FIG. 5. In this example, each RU l for l=1, . . . , L does respective UL channel estimation of H_{l,UL}∈ [symbol] ^{N}^{ₗ}^{×K}^{ₗ} and calculates the l-th part of intermediate BFWs H_{l,UL}^{H}H_{l,UL}. The channel estimation is saved and the combined intermediate BFWs C_{com,UL} are obtained similar to the DL process by combining the intermediate BFWs at RU l with the received combined intermediate BFWs from the previous RU. The combination is based on

$${\overline{H}}_{l , UL} ( : , k ) = \{ \begin{matrix}{H}_{l , UL} ( : , i ) & if k ∈ {l}_{} , and k = {l}_{} \{ i \} \\ 0 & if k ∉ {l}_{}\end{matrix}$$

The final combined intermediate BFWs C_{com,UL}=Σₗ₌₁^{L}H̅_{l,UL}^{H}H̅_{l,UL} is also a K×K matrix which will be sent to the BBU 222 over the fronthaul interface via RU 224a. Similar to the DL direction, the transporting of C_{com,UL} can be only based on the upper or lower triangular components of C_{com,UL}.

The BBU 222 then calculates the second part BFWs as W_{BBU,UL}=(C_{com,UL}+δ_{UL}²I)⁻¹ based on the received combined intermediate BFWs C_{com,UL}. The second part BFWs are then sent to the RU 224a, which also forwards the second part BFWs to the other RUs 224b-c in the cascaded chain. Similar to the DL direction, the transporting W_{BBU,UL} can be only based on the upper or lower triangular components of W_{BBU,UL}. If so, each RU 224a-c needs firstly to recover the original W_{BBU,UL} before using it for further BFWs calculation.

At RU l, it also determines BFWs W_{RU l,UL}=\acute{W}_{BBU,UL,l}H_{l,UL}^{H}∈ [symbol] ^{K}^{ₗ}^{×N}^{ₗ} where \tilde{W}_{BBU,UL,l} is composed by K, selected columns from W_{BBU,UL} where index information of which columns are selected is indicated by the received scheduling information from the BBU 222. Consequently, RU l conducts frequency-domain beamforming of its received UL signal xₗ∈ [symbol] ^{N}^{ₗ}^{×1} using the BFWs W_{RU l,UL}. By doing so, it obtains a beamformed signal yₗ=W_{RU l,UL}xₗ∈ [symbol] ^{K}^{ₗ}^{×1}.

RU l also receives a combined beamformed signal y_{com} from the previous RU. To differentiate between the received combined beamformed signal and the updated combined beamformed signal at RU l, the received combined beamformed signal is also denoted as y_{com,previous} where y_{com,previous}=Σₘ₌ₗ₋₁^{L}yₘ. RU l updates y_{com} using the obtained beamformed signal y, and the received y_{com},previous by

$${y}_{com} = {y}_{com , previous} + {y}_{l}$$

and sends the updated y_{com} to the next RU until it reaches RU 1. RU 1 sends the final combined beamformed signal y_{com} to the BBU 222. At any RU, each antenna receives one IQ data stream including the frequency-domain IQ data received from the antenna. The IQ data can be the combination of multiple user layer data sent from one or multiple UEs to a base station through a wireless channel. Therefore, each IQ data stream can be referred to as a user-layer data stream. In some examples, after the beamforming in each RU, the number of user-layer data stream is reduced from the number of antennas (e.g., N1, N2, or N3) to the number of layers (e.g., K). Here, each data stream of the reduced number of user-layer data streams after beamforming can be referred to as a beamformed user-layer data stream.

In some embodiments, both C-plane data (i.e., the second part BFWs W_{BBU,UL}) and U-plane data (i.e., the combined beamformed signal y_{com}) are communicated in dimensions that are only related to the number of user layers K, not with respect to the number of RUs L. In some examples, a BBU only calculates the first part BFWs and send them to each RUs via the cascaded chain. Similar to DL, BBU complexity is reduced. In addition, BFWs are sent in DL direction, which would not increase UL FH load. In TDD, there is no U-plane data in DL direction for UL slots. So, this is not an issue for DL FH load either.

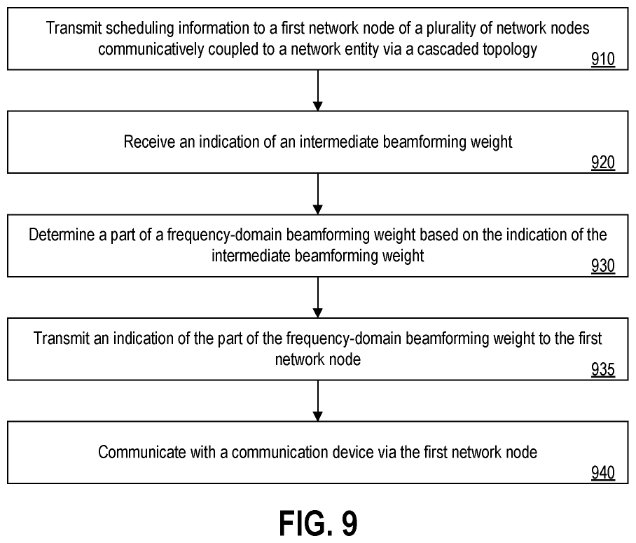

In the description that follows, while the network entity may be any of the BBU 222, RAN node 700, network node 1110A, 1110B, 1300, 1606, hardware 1504, or virtual machine 1508A, 1508B, the RAN node 700 shall be used to describe the functionality of the operations of the network entity. Operations of the RAN node 700 (implemented using the structure of FIG. 7) will now be discussed with reference to the flow chart of FIG. 9 according to some embodiments of inventive concepts. For example, modules may be stored in memory 705 of FIG. 7, and these modules may provide instructions so that when the instructions of a module are executed by respective RAN node processing circuitry 703, processing circuitry 703 performs respective operations of the flow chart.

FIG. 9 illustrates an example of operations performed by a network entity in a communications network that includes a plurality of network nodes communicatively coupled to the network entity via a cascaded topology. In some embodiments, the network entity includes a baseband unit, BBU, and each network node of the plurality of network nodes includes a radio unit, RU, with one or more antennas.

At block 910, processing circuitry 703 transmits, via network interface 707, scheduling information to a first network node of the plurality of network nodes. In some embodiments, the scheduling information including at least an indication of user layers to be used for communication during a next transmission time interval and an indication of which user layers will be served by the first network node. In additional or alternative embodiments, the scheduling information includes an indication of which user layers will be served by each network node in the plurality of network nodes. In additional or alternative embodiments, the scheduling information includes a modulation order for DL data that will be received by the first network node from the network entity.

At block 920, processing circuitry 703 receives, via network interface 707, an indication of an intermediate beamforming weight. In some embodiments, receiving the indication of the intermediate beamforming weight includes receiving an indication of a combined intermediate beamforming weight (e.g., C_{com} of FIGS. 4-5) from the first network node, the combined intermediate beamforming weight being a combination of intermediate beamforming weights (e.g., C₁ and C₂ of FIGS. 4-5) that are each associated with one of the plurality of network nodes.

In additional or alternative embodiments, the combined intermediate beamforming weight and the part of the frequency-domain beamforming weight are each a Hermitian matrix of size K×K, where K is a total number of user layers served by the network entity.

In additional or alternative embodiments, the indication of the combined intermediate beamforming weight and the indication of the part of the frequency-domain beamforming weight are each an indication of upper triangle components or lower triangle components of their respective Hermitian matrix.

In additional or alternative embodiments, the Hermitian matrix associated with the intermediate beamforming weight includes is a covariance matrix of a channel estimate of a channel between the first network node and the communication device.

At block 930, processing circuitry 703 determines a part of a frequency-domain beamforming weight (e.g., W_{BBU} described above) based on the indication of the intermediate beamforming weight. In some embodiments, determining the part of the frequency-domain beamforming weight includes: determining a regularization factor based on the intermediate beamforming weight; determining an identity matrix of size K×K, where K is a total number of user layers served by the network entity; and determining the part of the frequency-domain beamforming weight based on the inverse of an addition of the intermediate beamforming weight and a multiplication of the identity matrix and regularization factor.

At block 935, processing circuitry 703 transmits, via network interface 707, an indication of the part of the frequency-domain beamforming weight to the first network node. In some embodiments, transmitting the indication of the part of the frequency-domain beamforming weight includes transmitting an indication of the part of the frequency-domain beamforming weight to the first network node via a control plane.

At block 940, processing circuitry 703 communicates, via network interface 707, with a communication device via the first network node. In some embodiments, communicating the data with the communication device includes transmitting K data streams to the first network node, where K is a total number of user layers served by the network entity, the data streams each comprising coded bits, modulated symbols, or a beamformed user-layer data stream.

In additional or alternative embodiments, communicating the data with the communication device includes: receiving a beamformed uplink, UL, signal associated with the communication device from the first network node; and determining UL data based on the beamformed UL signal (also referred to as a beamformed UL user-layer data stream). In some examples, receiving the beamformed UL signal includes: receiving a combined beamformed UL signal from the first network node, the combined beamformed UL signal being a combination of beamformed UL signals that are each associated with one of the plurality of network nodes; and determining the beamformed UL signal based on the combined beamformed UL signal.

Various operations from the flow chart of FIG. 9 may be optional with respect to some embodiments of network entities and related methods.

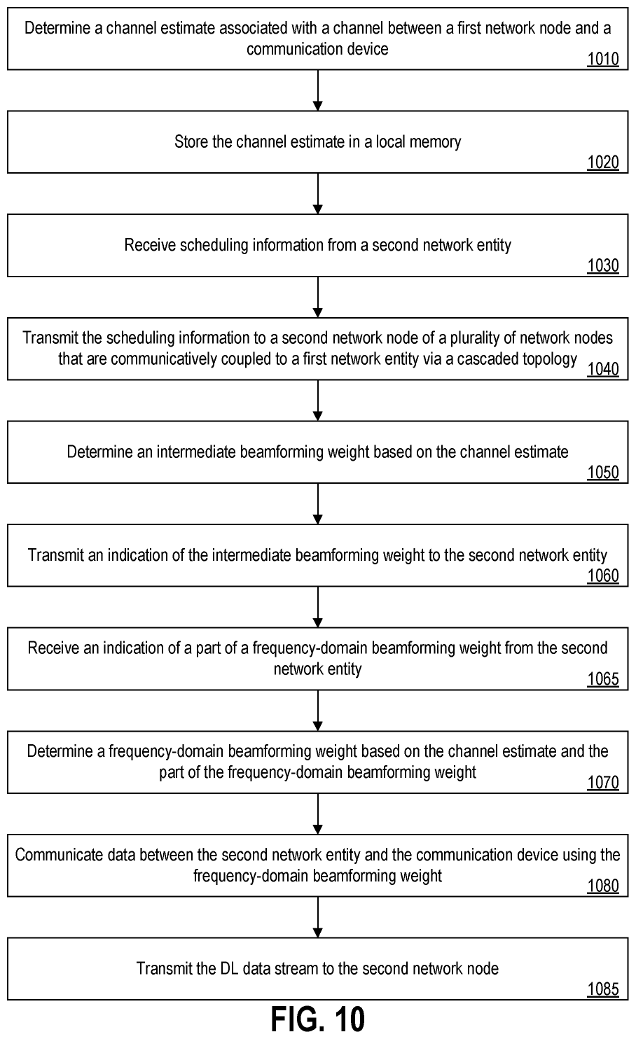

In the description that follows, while the first network node may be any of the RU 224a-c, RAN node 700, network node 1110A, 1110B, 1300, 1606, hardware 1504, or virtual machine 1508A, 1508B, the RAN node 700 shall be used to describe the functionality of the operations of the first network node. Operations of the RAN node 700 (implemented using the structure of FIG. 7) will now be discussed with reference to the flow chart of FIG. 10 according to some embodiments of inventive concepts. For example, modules may be stored in memory 705 of FIG. 7, and these modules may provide instructions so that when the instructions of a module are executed by respective RAN node processing circuitry 703, processing circuitry 703 performs respective operations of the flow chart.

FIG. 10 illustrates an example of operations performed by a first network node of a plurality of network nodes in a communications network, the plurality of network nodes being communicatively coupled to a first network entity via a cascaded topology.

At block 1010, processing circuitry 703 determines a channel estimate associated with a channel between a first network node and a communication device.

At block 1020, processing circuitry 703 stores the channel estimate in a local memory.

At block 1030, processing circuitry 703 receives, via network interface 707, scheduling information from a second network entity. In some embodiments, the second network entity is the first network entity and includes a baseband unit, BBU and each network node of the plurality of network nodes includes a radio unit, RU, with one or more antennas. In alternative embodiments, the first network entity includes a baseband unit, BBU, the plurality of network nodes includes the second network entity, and each network node of the plurality of network nodes includes a radio unit, RU, with one or more antennas.

In some embodiments, the scheduling information including at least an indication of user layers to be used for communication during a next transmission time interval and an indication of which user layers will be served by the first network node. In additional or alternative embodiments, the scheduling information includes an indication of which user layers will be served by each network node in the plurality of network nodes. In additional or alternative embodiments, the scheduling information includes a modulation order for DL data that will be received by the first network node from the network entity.

At block 1040, processing circuitry 703 transmits, via network interface 707, the scheduling information to a second network node of a plurality of network nodes that are communicatively coupled to a first network entity via a cascaded topology.

At block 1050, processing circuitry 703 determines an intermediate beamforming weight based on the channel estimate. In some embodiments, the intermediate beamforming weight includes a first intermediate beamforming weight (e.g., C₁ of FIGS. 4-5). Transmitting the indication of the intermediate beamforming weight can include: receiving an indication of a second intermediate beamforming weight (e.g., C₂ of FIGS. 4-5) from a second network node of the plurality of network nodes; combining the first intermediate beamforming weight and the second intermediate beamforming weight to form a combined intermediate beamforming weight (e.g., C_{com} of FIGS. 4-5); and transmitting an indication of the combined intermediate beamforming weight to the second network entity.

In additional or alternative embodiments, the first intermediate beamforming weight, the second beamforming weight, and the combined intermediate beamforming weight are each a Hermitian matrix of size K×K, where K is a total number of user layers.

In additional or alternative embodiments, the indication of the first intermediate beamforming weight, the indication of the second beamforming weight, and the indication of the combined intermediate beamforming weight are each an indication of upper triangle components or lower triangle components of their respective Hermitian matrix.

In additional or alternative embodiments, the Hermitian matrix associated with the first intermediate beamforming weight is a covariance matrix of the channel estimate.

At block 1060, processing circuitry 703 transmits, via network interface 707, an indication of the intermediate beamforming weight to the second network entity. In some embodiments, the intermediate beamforming weight includes a first intermediate beamforming weight. Transmitting the indication of the intermediate beamforming weight includes: receiving an indication of a second intermediate beamforming weight from a second network node of the plurality of network nodes; combining the first intermediate beamforming weight and the second intermediate beamforming weight to form a combined intermediate beamforming weight; and transmitting an indication of the combined intermediate beamforming weight to the second network entity.

At block 1065, processing circuitry 703 receives, via network interface 707, an indication of a part of a frequency-domain beamforming weight from the second network entity.

At block 1070, processing circuitry 703 determines a frequency-domain beamforming weight based on the channel estimate and the part of the frequency-domain beamforming weight. In some embodiments, determining the frequency-domain beamforming weight includes determining the frequency-domain beamforming weight based on a conjugate transpose of the channel estimate and the part of the frequency-domain beamforming weight.

At block 1080, processing circuitry 703 communicates, via transceiver 701 and network interface 707, data between the second network entity and the communication device using the frequency-domain beamforming weight. In some embodiments, receiving the scheduling information includes receiving an indication of user layers to be transmitted in the next transmission time interval. Communicating the data includes receiving a downlink, DL, data stream from the first network node, the DL data stream including DL coded bits or DL modulated symbols; generating a beamformed DL signal based on the DL data stream and the frequency-domain beamforming weight; and transmitting the beamformed DL signal to the communication device. In additional or alternative embodiments, generating the beamformed DL signal includes: generating frequency-domain user-layer in-phase and quadrature, IQ, data from the DL data stream based on the scheduling information; and generating the beamformed DL signal by beamforming the frequency-domain user-layer IQ data using the frequency-domain beamforming weight. In some examples, receiving the DL data stream includes receiving DL coded bits. The scheduling information includes an indication of a modulation order of the DL coded bits and generating the beamformed DL signal includes modulating the DL coded bits using the modulation order to generate the DL modulated symbols. The DL modulated symbols can be beamformed to generate the beamformed DL signal.

In some embodiments (e.g., in DL in which the first network node is not the last network node in the chain of network nodes), at block 1085, processing circuitry 703 transmits, via network interface 707, the DL data stream to the second network node. In some examples, the DL data stream includes coded bits or modulated symbols. In additional or alternative embodiments, the first network node received coded bits, modulates the coded bits, and transmits the modulated coded bits to the second network node.

In additional or alternative embodiments, receiving the scheduling information includes receiving an indication of user layers to be received in the next transmission time interval. Communicating the data includes: receiving an uplink, UL, signal from the communication device; generating beamformed UL signal based on the UL signal and the frequency-domain beamforming weight; and transmitting the beamformed UL signal to the second network entity.

In some examples, the beamformed UL signal is a first beamformed UL signal. Transmitting the beamformed UL signal to the second network entity includes: receiving a second beamformed UL signal from the second network node; combining the first beamformed UL signal and the second beamformed UL signal to form a combined beamformed UL signal; and transmitting the combined beamformed UL signal to the second network entity.

In some embodiments, the first intermediate beamforming weight, the second intermediate beamforming weight, the combined intermediate beamforming weight, and the part of the frequency-domain beamforming weight are each a Hermitian matrix of size K×K, where K is a total number of user layers served by the first network entity. In additional or alternative embodiments, the indication of the first intermediate beamforming weight, the second intermediate beamforming weight, the combined intermediate beamforming weight, and the indication of the part of the frequency-domain beamforming weight are each an indication of upper triangle components or lower triangle components of their respective Hermitian matrix. In some examples, the Hermitian matrix associated with the first intermediate beamforming weight includes a covariance matrix of the channel estimate.

Various operations from the flow chart of FIG. 10 may be optional with respect to some embodiments of network entities and related methods. For example, block 1010, 1020, 1040, and 1085 may be optional.

FIG. 11 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3rd Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

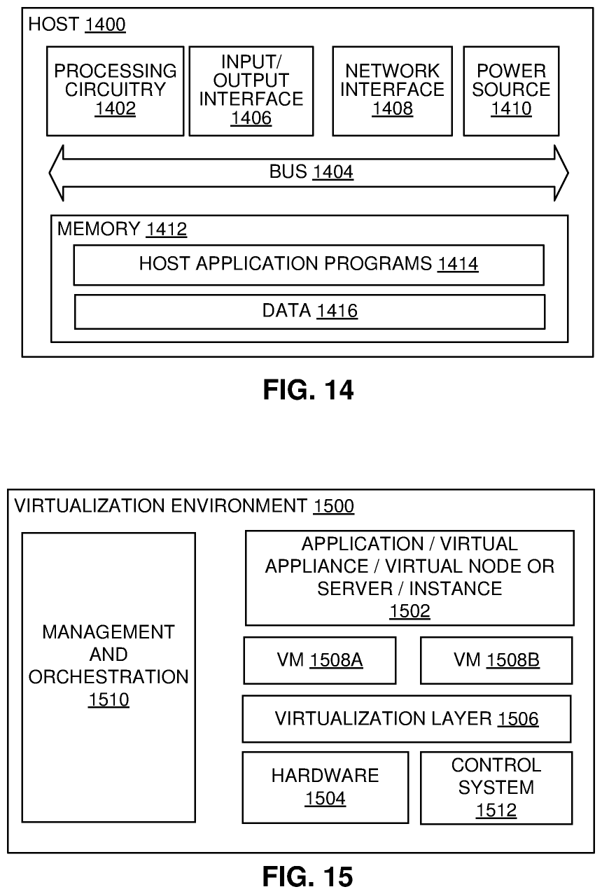

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12-13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve the performance of centralized beamforming in a massive D-MIMO system without suffering from an exploding fronthaul load associated with a large number of RUs connecting to the BBU in a cascaded topology and thereby provide benefits such as reducing both the deployment costs (due to the reduced number or length of required fibers) and the system complexity (due to the reduced number of required BBU ports) compared with the star topology. In some embodiments, a BBU saves some complexity since modulation and beamforming are performed in respective RU. In additional or alternative embodiments, in the U-plane, only coded bits are sent from BBU to each RU, which can be more compressed.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method performed by a network entity in a communications network, the communications network including a plurality of network nodes communicatively coupled to the network entity via a cascaded topology, the method comprising:
transmitting scheduling information to a first network node of the plurality of network nodes, the scheduling information including at least an indication of user layers to be used for communication with a communication device during a next transmission time interval and an indication of which user layers will be served by the first network node;
receiving an indication of an intermediate beamforming weight from the first network node;
determining a part of a frequency-domain beamforming weight based on the indication of the intermediate beamforming weight;
transmitting an indication of the part of the frequency-domain beamforming weight to the first network node; and
communicating data with the communication device via the first network node.

2. The method of claim 1, wherein receiving the indication of the intermediate beamforming weight comprises receiving an indication of a combined intermediate beamforming weight from the first network node, the combined intermediate beamforming weight being a combination of intermediate beamforming weights that are each associated with one of the plurality of network nodes.

3. The method of claim 2, wherein the combined intermediate beamforming weight and the part of the frequency-domain beamforming weight are each a Hermitian matrix of size K×K, where K is a total number of user layers served by the network entity.

4. The method of claim 3, wherein the indication of the combined intermediate beamforming weight and the indication of the part of the frequency-domain beamforming weight are each an indication of upper triangle components or lower triangle components of their respective Hermitian matrix.

5. The method of claim 3, wherein the Hermitian matrix associated with the intermediate beamforming weight comprises a covariance matrix of a channel estimate of a channel between the first network node and the communication device.

6. The method of claim 1, wherein determining the part of the frequency-domain beamforming weight comprises:
determining a regularization factor based on the intermediate beamforming weight;
determining an identity matrix of size K×K, where K is a total number of user layers served by the network entity; and
determining the part of the frequency-domain beamforming weight based on the inverse of an addition of the intermediate beamforming weight and a multiplication of the identity matrix and the regularization factor.

7. (canceled)

8. (canceled)

9. The method of claim 1, wherein communicating the data with the communication device comprises:
receiving a beamformed uplink, UL, user-layer data stream associated with the communication device from the first network node; and
determining UL data based on the beamformed UL user-layer data stream.

10. The method of claim 9, wherein receiving the beamformed UL user-layer data stream comprises:
receiving a combined beamformed UL user-layer data stream from the first network node, the combined beamformed UL user-layer data stream being a combination of beamformed UL user-layer data streams that are each associated with one of the plurality of network nodes; and
determining the beamformed UL user-layer data stream based on the combined beamformed UL user-layer data stream.

11. (canceled)

12. A method performed by a first network node of a plurality of network nodes in a communications network, the plurality of network nodes being communicatively coupled to a first network entity via a cascaded topology, the method comprising:
receiving scheduling information from a second network entity in the communications network, the scheduling information including at least an indication of user layers to be used for communication with a communication device in a next transmission time interval and an indication of which user layers will be served by the first network node;
determining an intermediate beamforming weight based on a channel estimate associated with a channel between the first network node and the communication device;
transmitting an indication of the intermediate beamforming weight to the second network entity;
receiving an indication of a part of a frequency-domain beamforming weight from the second network entity;
determining a frequency-domain beamforming weight based on the channel estimate and the part of the frequency-domain beamforming weight; and
communicating data between the second network entity and the communication device using the frequency-domain beamforming weight.

13. The method of claim 12, wherein the intermediate beamforming weight comprises a first intermediate beamforming weight, and wherein transmitting the indication of the intermediate beamforming weight comprises:
receiving an indication of a second intermediate beamforming weight from a second network node of the plurality of network nodes;
combining the first intermediate beamforming weight and the second intermediate beamforming weight to form a combined intermediate beamforming weight; and
transmitting an indication of the combined intermediate beamforming weight to the second network entity.

14. The method of claim 13, wherein the first intermediate beamforming weight, the second intermediate beamforming weight, the combined intermediate beamforming weight, and the part of the frequency-domain beamforming weight are each a Hermitian matrix of size K×K, where K is a total number of user layers served by the first network entity.

15. The method of claim 14, wherein the indication of the first intermediate beamforming weight, the second intermediate beamforming weight, the combined intermediate beamforming weight, and the indication of the part of the frequency-domain beamforming weight are each an indication of upper triangle components or lower triangle components of their respective Hermitian matrix.

16. The method of claim 13, wherein the Hermitian matrix associated with the first intermediate beamforming weight comprises a covariance matrix of the channel estimate.

17. The method of claim 12, wherein receiving the scheduling information comprises receiving an indication of user layers to be transmitted in the next transmission time interval, and wherein communicating the data comprises:
receiving a downlink, DL, data stream from the first network node, the DL data stream comprising DL coded bits or DL modulated symbols;
generating a beamformed DL signal based on the DL data stream and the frequency-domain beamforming weight; and
transmitting the beamformed DL signal to the communication device.

18. (canceled)

19. (canceled)

20. The method of claim 17, wherein receiving the DL data stream comprises receiving a plurality of DL data streams, the method further comprising:
responsive to receiving the scheduling information, transmitting the scheduling information to a second network node of the plurality of network nodes; and
responsive to receiving the plurality of DL data streams, transmitting the plurality of DL data streams to the second network node.

21. The method of claim 12, wherein receiving the scheduling information comprises receiving an indication of user layers to be received in the next transmission time interval, wherein communicating the data comprises:
receiving an uplink, UL, signal from the communication device;
generating beamformed UL signal based on the UL signal and the frequency-domain beamforming weight; and
transmitting the beamformed UL signal to the second network entity.

22. The method of claim 21, further comprising:
responsive to receiving the scheduling information, transmitting the scheduling information to a second network node of the plurality of network nodes;
wherein the beamformed UL signal is a first beamformed UL signal; and
wherein transmitting the beamformed UL signal to the second network entity comprises:
receiving a second beamformed UL signal from the second network node;
combining the first beamformed UL signal and the second beamformed UL signal to form a combined beamformed UL signal; and
transmitting the combined beamformed UL signal to the second network entity.

23. (canceled)

24. (canceled)

25. The method of claim 12, wherein the second network entity is the first network entity and comprises a baseband unit, BBU, and wherein each network node of the plurality of network nodes comprises a radio unit, RU, with one or more antennas.

26. The method of claim 12, wherein the first network entity comprises a baseband unit, BBU, wherein the plurality of network nodes comprises the second network entity, and wherein each network node of the plurality of network nodes comprises a radio unit, RU, with one or more antennas.

27. (canceled)

28. A network entity in a communications network, the communications network including a plurality of network nodes communicatively coupled to the network entity via a cascaded topology, the network entity comprising:
processing circuitry; and
memory coupled to the processing circuitry and having instructions stored therein that are executable by the processing circuitry to cause the network entity to:
transmit scheduling information to a first network node of the plurality of network nodes, the scheduling information including at least an indication of user layers to be used for communication with a communication device during a next transmission time interval and an indication of which user layers will be served by the first network node;
receive an indication of an intermediate beamforming weight from the first network node;
determine a part of a frequency-domain beamforming weight based on the indication of the intermediate beamforming weight;
transmit an indication of the part of the frequency-domain beamforming weight to the first network node; and
communicate data with the communication device via the first network node.

29.-32. (canceled)

33. A first network node in a communications network, the first network node comprising:
processing circuitry; and
memory coupled to the processing circuitry and having instructions stored therein that are executable by the processing circuitry to cause the first network node to:
receive scheduling information from a second network entity in the communications network, the scheduling information including at least an indication of user layers to be used for communication with a communication device in a next transmission time interval and an indication of which user layers will be served by the first network node;
determine an intermediate beamforming weight based on a channel estimate associated with a channel between the first network node and the communication device;
transmit an indication of the intermediate beamforming weight to the second network entity;
receive an indication of a part of a frequency-domain beamforming weight from the second network entity;
determine a frequency-domain beamforming weight based on the channel estimate and the part of the frequency-domain beamforming weight; and
communicate data between the second network entity and the communication device using the frequency-domain beamforming weight.

34.-37. (canceled)
